(19) United States
(12) Patent Application Publication
(10) Pub. No.: US 2022/0318015 A1
(43) Pub. Date: Oct. 6, 2022

(54) ENFORCING DATA PLACEMENT REQUIREMENTS VIA ADDRESS BIT SWAPPING

(71) Applicant: ADVANCED MICRO DEVICES, INC., SANTA CLARA, CA (US)

(72) Inventors: JOHNATHAN ALSOP, BELLEVUE, WA (US); SHAIZEEN AGA, SANTA CLARA, CA (US)

(21) Appl. No.: 17/218,994

(22) Filed: Mar. 31, 2021

(51) Int. Cl. G06F 9/32; G06F 9/38

(52) U.S. Cl. CPC G06F 9/322; G06F 9/3836

(57) ABSTRACT

Enforcing data placement requirements via address bit swapping, including: receiving an instruction comprising a first memory address associated with a first address bit mapping; generating a remapped instruction by rearranging a plurality of bits of the first memory address according to a second address bit mapping; and issuing the remapped instruction to memory.

### BACKGROUND

Technologies such as processing in memory (PIM) and non-uniform memory access (NUMA)-aware algorithms allow programmers to leverage increasing compute capabilities by alleviating memory bandwidth bottlenecks. To do so, software functions must be written with awareness of where data will be placed and acted upon in memory. If the software itself is written assuming a particular memory mapping, code portability becomes difficult as such mapping are likely to change across different architectures.

### BRIEF DESCRIPTION OF THE DRAWINGS

FIG. 1 is a block diagram of an example system for enforcing data placement requirements via address bit swapping according to some embodiments.

FIG. 2 is a diagram of an example address bit swapping across address bit mappings for according to some embodiments.

FIG. 3 is a diagram of an example memory mapping for general matrix vector multiplication using enforcing data placement requirements via address bit swapping according to some embodiments.

FIG. 4 is a diagram of an example pool layer of a convolutional neural network using enforcing data placement requirements via address bit swapping according to some embodiments.

FIG. 5 is a diagram of an example memory access pipeline for enforcing data placement requirements via address bit swapping according to some embodiments.

FIG. 6 is a flowchart of an example method for enforcing data placement requirements via address bit swapping according to some embodiments.

FIG. 7 is a flowchart of another example method for enforcing data placement requirements via address bit swapping according to some embodiments.

FIG. 8 is a flowchart of another example method for enforcing data placement requirements via address bit swapping according to some embodiments.

FIG. 9 is a flowchart of another example method for enforcing data placement requirements via address bit swapping according to some embodiments.

FIG. 10 is a flowchart of another example method for enforcing data placement requirements via address bit swapping according to some embodiments.

### DETAILED DESCRIPTION

In some embodiments, a method of enforcing data placement requirements via address bit swapping includes: receiving an instruction including a first memory address associated with a first address bit mapping; generating a remapped instruction by rearranging a plurality of bits of the first memory address according to a second address bit mapping; and issuing the remapped instruction to memory.

In some embodiments, the second address bit mapping corresponds to a hardware architecture associated with an execution of the instruction. In some embodiments, the method further includes determining the first address bit mapping by accessing data indicating the first address bit mapping. In some embodiments, the data indicating the first address bit mapping is stored in a page table. In some embodiments, the data indicating the first address bit mapping is stored in a mapping register. In some embodiments, the data indicating the first address bit mapping includes a bit mask indicating a plurality of bits that will not change for addresses that will be accessed together in one or more data structures. In some embodiments, the method further includes determining to generate the remapped instruction in response to the first memory address being included in a particular address range. In some embodiments, the method further includes determining to generate the remapped instruction in response to an operand of the instruction. In some embodiments, the method further includes determining to generate the remapped instruction in response to a prior execution of another instruction indicating that address bit swapping should be performed.

In some embodiments, an apparatus for enforcing data placement requirements via address bit swapping performs steps including: receiving an instruction including a first memory address associated with a first address bit mapping; generating a remapped instruction by rearranging a plurality of bits of the first memory address according to a second address bit mapping; and issuing the remapped instruction to memory.

In some embodiments, the second address bit mapping corresponds to a hardware architecture associated with an execution of the instruction. In some embodiments, the steps further include determining the first address bit mapping by accessing data indicating the first address bit mapping. In some embodiments, the data indicating the first address bit mapping is stored in a page table. In some embodiments, the data indicating the first address bit mapping is stored in a mapping register. In some embodiments, the data indicating the first address bit mapping includes a bit mask indicating a plurality of bits will not change for addresses that will be accessed together in one or more data structures. In some embodiments, the steps further include determining to generate the remapped instruction in response to the first memory address being included in a particular address range. In some embodiments, the steps further include determining to generate the remapped instruction in response to an operand of the instruction. In some embodiments, the steps further include determining to generate the remapped instruction in response to a prior execution of another instruction indicating that address bit swapping should be performed.

In some embodiments, a computer program product disposed upon a non-transitory computer readable medium includes computer program instructions for enforcing data placement requirements via address bit swapping that, when executed, cause a computer system to perform steps including: receiving an instruction including a first memory address associated with a first address bit mapping; generating a remapped instruction by rearranging a plurality of bits of the first memory address according to a second address bit mapping; and issuing the remapped instruction to memory.

In some embodiments, the second address bit mapping corresponds to a hardware architecture associated with an execution of the instruction.

Technologies such as processing in memory (PIM) and non-uniform memory access (NUMA) allow programmers to leverage increased compute capabilities by alleviating memory bandwidth bottlenecks. To do so, software functions must be written with awareness of where data will be placed and acted upon in memory. For example, to perform a vector-based PIM operation, a software application might need to ensure that data within a same vector are contiguous in memory. Similarly, to perform a PIM operation on two addresses in memory, a software application might need to ensure that both addresses are placed in the same memory bank. The PIM operation is then sent to the particular memory bank and executed by PIM logic close to the memory bank, saving on memory bandwidth that would otherwise be used to communicate between memory and a compute node via a memory interface. Such techniques require programmer awareness of architecture-specific memory placement details in order to develop functions targeting particular memory hardware (e.g., particular memory banks). In other words, software must be written to leverage the mapping between virtual memory addresses and the physical memory addresses of particular memory modules.

If the software itself is written assuming a particular memory mapping, code portability becomes difficult as such mapping are likely to change across different architectures. If a mapping function is programmed dynamically based on a data interleaving strategy for different workloads, this adds additional complexity to any mapping-aware software. Additionally, programmer productivity is affected due to the additional complexity of developing software for particular architectures and memory mapping schemes.

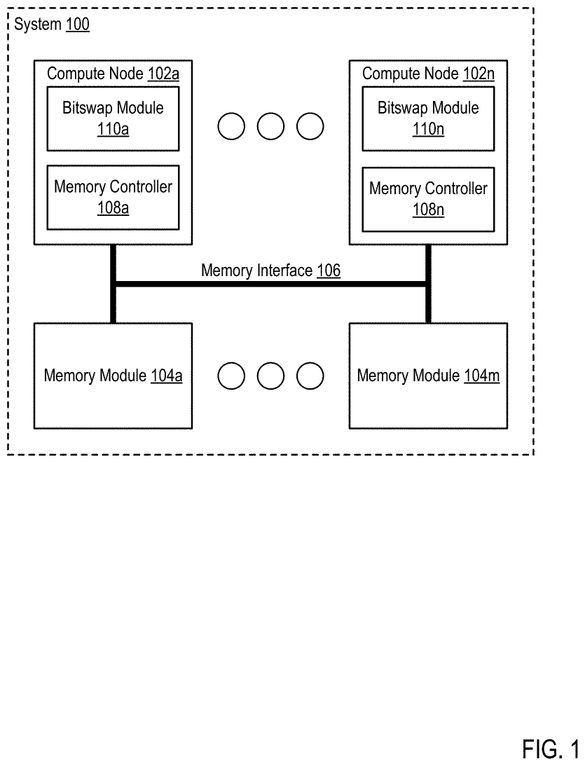

To address these concerns, FIG. 1 shows a block diagram of a non-limiting example system 100 for enforcing data placement requirements via address bit swapping according to embodiments of the present disclosure. The example system 100 can be implemented in a variety of computing devices, including mobile devices, personal computers, gaming devices, set-top boxes, and the like. The system 100 includes multiple compute nodes 102a-n. The compute nodes 102a-n include a physical allocation or subunit of compute resources, such as processing resources. For example, each compute node 102a-n includes a processor, a core, or other subunit of processing resources. In some embodiments, each compute node 102a-n includes an instruction execution pipeline that allows loading, execution, and commitment of instructions. For example, in some embodiments, the compute nodes 102a-n facilitate, in aggregate, parallel computation or execution of instructions.

The system 100 also includes multiple memory modules 104a-n. The memory banks 104a-m are logical units of memory each including multiple rows and columns of storage units. In some embodiments, the memory banks 104a-m each include one or more memory banks. As an example, the memory modules 104a-n include random access memory (RAM) such as synchronous dynamic random-access memory (SDRAM), double data rate synchronous dynamic random-access memory (DDR SDRAM), or other RAM as can be appreciated.

The memory modules 104a-m are communicatively coupled to the compute nodes 102a-n via a memory interface 106. The memory interface 106 includes one or more memory buses, signal pathways, switch fabric interfaces, or combinations thereof to provide communications paths between the compute nodes 102a-n and memory modules 104a-m, thereby allowing the compute nodes 102a-nto issue memory accesses operations or other instructions (hereinafter collectively referred to as “memory accesses”) to a targeted memory module 104a-m. In some embodiments, such memory accesses include, for example, read or write operations, PIM operations, and the like.

To facilitate the issuance of memory access from a compute node 102a-n to a memory module 104a-m via the memory interface 106, each compute node 102a-n includes a respective memory controller 108a-n that issues instructions to memory. In some embodiments, the memory controllers 108a-n include cache controllers, and the memory modules 104a-m include cache memory. In other embodiments, the memory controllers 108a-n are controllers that issue operations to RAM or other memory as can be appreciated. Each memory interface 106 is included in or coupled to an instruction execution pipeline such that instructions that include memory accesses targeting memory (e.g., targeting a particular memory module 104a-m), when executed, issue the memory accesses to the correct memory module 104a-m. For example, in some embodiments where the system 100 exhibits NUMA peroperties, each compute node 102a-n includes a high bandwidth memory controller 108a-n coupled to high bandwidth memory (HBM) stacks of memory modules 104a-m. As another example, in some embodiments where the system 100 allows for PIM operations, each memory module 104a-m includes corresponding PIM logic (e.g., vector computation logic and the like) for applying PIM operations to the memory module 104a-m, and each memory controller 108a-n is coupled to the PIM logic via the memory interface 106.

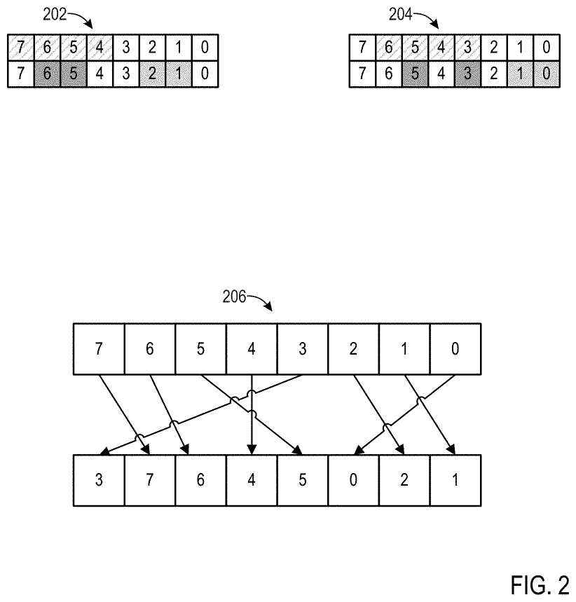

As is set forth above, software including certain operations such as PIM operations are developed assuming a particular mapping between virtual memory addresses and how those addresses are partitioned among physical memory modules 104a-m. As such, particular bits encoding the PIM operation are assumed to encode particular information of the memory access required to perform the PIM operation. For example, turning to item 202 of FIG. 2, assume that, of the eight bits encoding address information for a PIM operation, bits 1-2 determine the offset of an element in the PIM vector operation (a single PIM vector operation will touch all addresses that differ in these bits from the target address), bits 4-7 determine the bank ID of the target address (channel and bank offset), and bits 5-6 determine the bank offset within a channel of the target address (a PIM command that targets all memory banks in a channel—referred to as an all-bank command—will touch all addresses that differ in these bits from the target address). The software using the PIM operation must be aware of this mapping information (e.g., an “address bit mapping”) because the software determines which elements are accessed when a PIM operation is issued, and determines which elements are able to be accessed together within a single PIM module (e.g., a single memory module 104a-m including PIM logic elements).

If software written assuming the address bit mapping of item 202 is executed on a different architecture using a different mapping, the PIM operation is subject to failure. For example, consider an architecture using the address bit mapping of item 204, where address bits 0 and 1 determine the offset of an element in the PIM operation, bits 3-6 determine the bank ID, and bits 3 and 5 determine the bank offset within a channel. Here, an operation written assuming the address bit mapping of item 202, when executed on an architecture using the address bit mapping of item 204, can fail as the addresses will map to different memory modules 104a-m. Similarly, given a base address for an all-bank PIM operation or a SIMD vector operation, the addresses software expects to be accessed in a given all-bank or SIMD vector command differ from which addresses will be accessed in hardware.

Accordingly, a bitswap module 110a-n rearranges one or more bits of a memory address in a memory access conforming to a first address bit mapping such that the resulting memory address conforms to the second address bit mapping. For example, assuming that an executed operation or instruction includes a memory access to a memory address encoded according to a software-assumed address bit mapping (e.g., of the hardware architecture for which the software was written), the bitswap module 110a-n rearranges the one or more bits of the memory address to conform to an address bit mapping for the hardware architecture executing the operation or instruction. As an example, item 206 of FIG. 2 shows how the address bit mapping of item 202 would be rearranged of the address bit mapping of item 204. Such rearranging of bits is hereinafter referred to as an “address bit swap.” Instead of rewriting software for every possible hardware address mapping pattern or forcing hardware to map addresses according to software mapping assumption, the use of address bit swapping transforms the address of each memory access to match the underlying hardware before they are issued to the memory system (e.g., to memory modules 104a-n).

In some embodiments, the bitswap module 110a-n is embodied as dedicated hardware logic, software logic, or combinations thereof included in the memory controller 108a-n. In some embodiments, the bitswap module 110a-n is embodied as dedicated hardware logic, software logic, or combinations thereof separate from the memory controller 108a-n. For example, in some embodiments, the bitswap module 110a-n is implemented as software executed in a corresponding compute node 102a-n. In some embodiments, the bitswap module 110a-n is implemented in part by the software generating instructions that include memory accesses whose memory address bits will be swapped. In some embodiments, the bitswap module 110a-n is embodied in part by the memory controller 108a-n and in part by logic independent of the memory controller 108a-n. For example, in some embodiments, the bitswap module 110a-n is implemented in part as software executed in a compute node 102a-n that accesses dedicated logic, registers, and the like included in or independent from the memory controller 108a-n.

Continuing with the example of FIG. 2, assuming a PIM command to add together two elements A and B in memory, the PIM software will ensure that the addresses of elements to be combined in PIM from A and B do not differ in bits 4-7, although they are allowed to differ in every other bit. When an all-bank PIM command is issued, it is assumed to apply to the base address plus all elements that differ from the base address in bits 1, 2, 5, and 6. To correctly execute this on the specified hardware architecture, the address bits of any access to the data structures in question are swapped such that elements to be combined in A and B will only differ in address bits 3-6, and the data expected to be accessed by a single all-bank PIM command will differ in bits 0, 1, 3, and 5. As long as all accesses to the target data structure perform this address bit swap, the functionality of the original program will remain unchanged.

In some embodiments, the system 100 performs address bit swapping for various differing address bit mappings to the address bit mapping of the hardware architecture of the system 100. For example, different address bit mapping strategies are implemented in software for different data structures, different threads, or different functions. Accordingly, in some embodiments, a logical group of virtual memory addresses called an “allocation” is defined programmatically. All memory addresses within a given allocation are subject to the same address bit mapping strategy, with each allocation being non-overlapping.

To perform address bit swap remapping to a hardware address bit mapping, the bitswap module 110a-n must have knowledge of or access to the address bit mapping assumed by software (e.g., the “software address bit mapping”). Accordingly, in some embodiments, the bitswap module 110a-n accesses one or more registers storing data describing the software address bit mapping. In some embodiments, such registers are dedicated registers included in the dedicated hardware of the bitswap module 110a-n. In other embodiments, such registers are general purpose registers or memory locations selected for use in storing the data describing the software address bit mapping. Such registers storing data describing a particular address bit mapping are hereinafter referred to as “mapping registers.” In other embodiments, the data describing the software address bit mapping is stored in a page table. For example, assuming that allocations as described above are restricted to page-granularity address spaces, the page table stores the data describing the address bit mapping for the corresponding page allocation.

In some embodiments, the data describing the software address bit mapping includes a bitmask indicating the set of address bits that are guaranteed not to change for addresses that are accessed together for a given data structure. In some embodiments, this set of address bits is defined by the architecture the software was designed for (i.e., the bits that are expected to specify bank offset on the target architecture). In some embodiments, the data describing the address bit mapping also includes, for multi-address commands, information needed to determine which addresses are assumed to be accessed given a target base address (e.g., for PIM commands this will be the address bits indicating SIMD vector offset and the address bits indicating bank offset within a single channel).

When performing a bitswap, it is important that the remapped address falls in a legal memory allocation. One way to enforce this is to ensure, when allocating memory for a structure that may require bitswap, that all remapped addresses for an allocated structure will be remapped into the same allocation (in many cases this simply requires padding the allocation to a power of two). Ensuring this requires the OS to be aware of the physical address bit mapping and the software address bit mapping at the point of allocation, so there must be a mechanism for the OS to query both (or for software to communicate this to OS at allocation time). Alternatively, this check could be performed when the software address bit mapping is set for an allocation, or when the bitswap is performed (to ensure the remapped address does not fall in an illegal allocation) and trigger an error if such a check fails. The check is performed in hardware, software, or combinations thereof.

As an example, a kernel designed for a bank-local PIM architecture that interleaves a contiguous, aligned, 2 GB PIM structure at 128 B granularity across 1024 banks in a round-robin fashion would indicate that address bits 8-17 and 32+ are guaranteed to be the same for all addresses that are accessed together (i.e., at the same PIM unit). This is because bits 8-17 indicate the bank ID, which must be the same for elements accessed together in bank-local PIM, and bits over 23 must be the same because the structure is contiguous in memory (e.g., won't span more than a single 4 GB boundary). Additionally, if the kernel is known to only combine elements from the first half of the array with elements 1 GB away in the second half of the array, the software can specify that all address bits except bit 30 are guaranteed to be the same for any addresses accessed together. As another example, a kernel designed for a NUMA system that divides a contiguous, aligned, 16 GB square 2-D matrix of 32 b ints in 16 square tiles across 16 NUMA nodes would indicate that address bits 15-16 (node X index), 32-33 (node Y index), and 34+ (same for the entire structure) will be the same for addresses that are likely to be accessed together (i.e., are in the same tile). In both cases, this information may be explicitly provided by the programmer, or inferred statically at compile time or dynamically at runtime.

In some embodiments, the bitswap module 110a-n performs address bit swapping in response to the execution of a particular instruction indicating that address bit swapping should be performed. For example, execution of a “bitswap start” instruction triggers entry into an address bit swap mode whereby subsequently executed instructions including a memory access would be subject to an address bit swap of memory address bits. Execution of a “bitswap end” instruction would end the address bit swap mode, whereby subsequently executed instructions with memory accesses would be issued to memory without address bit swapping. In some embodiments, the bitswap start instruction includes, as an operand, an identifier of a mapping register storing the data indicating the software address bit mapping to be used in the address bit swap.

In some embodiments, the bitswap module 110a-n performs address bit swapping in response to an operand of an instruction (e.g., the instruction including the memory access). Thus, instructions that access memory and do not include the particular operand will not be subject to an address bit swap by the bitswap module 110a-n, while instructions that access memory and do include the particular operand will be subject to an address bit swap. In some embodiments, the operand includes an identifier of a mapping register storing data indicating the address bit mapping to be used in the address bit swap. In other embodiments, this mapping register identifier is included as an additional operand.

In some embodiments, the bitswap module 110a-n performs address bit swapping in response to a memory address of an instruction being included in a predefined range of memory addresses (e.g., in a previously defined allocation of memory addresses for the address bit swap). Thus, an instruction having a memory address included in a particular allocation of memory addresses will be subject to the address bit swapping corresponding to the allocation.

In order to perform a particular address bit swap, the bitswap module 110a-n requires the software address bit mapping (e.g., stored in a mapping register or in a page table entry) as well as the address bit mapping used by the hardware architecture executing the software and instructions that access memory. This hardware address bit mapping is stored, for example, in another mapping register or other predefined area of memory. In some embodiments, the hardware address bit mapping is stored by a kernel, operating system, a boot process, or other process as can be appreciated.

In some embodiments, an operating system enforces various correctness requirements for a bitswapped address to ensure that memory is correctly allocated, and that there are no collisions or other faults associated with remapped memory addresses resulting from a bitswap. For example, in some embodiments, a memory allocation interface is augmented in PIM and NUMA systems to ensure data placement matches what is expected by software (e.g., to ensure data elements to be operated on together fall in the same memory module). In such embodiments, additional changes are needed to enable bitswapping.

In some embodiments, if processes are able to communicate their preferred data layout for a data structure at allocation time, then the memory allocator infers the range of remapped addresses and automatically expand the allocated space to include all remappings, preventing remapping collisions from different data structures structures. In other embodiments, the allocation generates a fault or return a non-remap-safe allocation. In some of these embodiments, the system then reverts to a non-PIM or non-NUMA-aware implementation.

In some embodiments, a PIM or NUMA-aware program will require that multiple separate allocations must be correctly aligned in the physical memory modules. One way to enforce this is to request that these allocations are aligned at a granularity greater than or equal to the most significant memory module ID bit, assuming this is known by the software. However, choosing this statically is not very portable or flexible. A better solution is to indicate to the OS that two allocations should be aligned, and allow the OS to align these allocations based on the address mapping in hardware. This enables improved portability even for codes without bitswapping, however it is particularly important for bitswapping systems, where software will often have different assumptions about underlying mappings.

In some embodiments, a PIM or NUMA-aware program will require that certain ranges of virtual addresses in a single allocation map to the same physical memory modules. One way to enforce this is to use a page size larger than the most significant memory module ID bit such that page translation does not affect memory module ID. However, as with alignment, choosing this statically is not very portable or flexible. An alternative solution is to indicate to the OS which bits are expected to be the same for any addresses accessed together (already provided by the bitswapping mapping info), and ensure that a sufficiently large page size is used such that these bits (after remapping, if bitswapping is enabled) are not affected by translation.

In some embodiments, the page table tracks which remapping is be used to access a given allocation (if any) and trigger a fault if a thread attempts to access it with a different remapping, preventing errors due to threads accessing data with inconsistent remappings.

Various use cases and embodiments benefit from the approaches set forth herein for enforcing data placement requirements via address bit swappings. For example, general matrix vector multiplication (GEMV) involves multiple independent parallel reductions of dot products between a vector and the columns of a matrix. In some embodiments, performance benefits occur where the matrix elements involved in each reduction to map to the same memory module. In the case of PIM, this is necessary for reduction to occur in a single PIM module. In the case of NUMA systems, this is desirable so that a compute element only needs to access local data. However, when elements to be reduced are organized continuously in memory, address interleaving prevents this kind of organization. By remapping the address space for the matrix at both the producer side and the consumer (GEMV kernel side), elements to be reduced can be forced to reside in the same memory module without changing the software indexing or the interleaving.

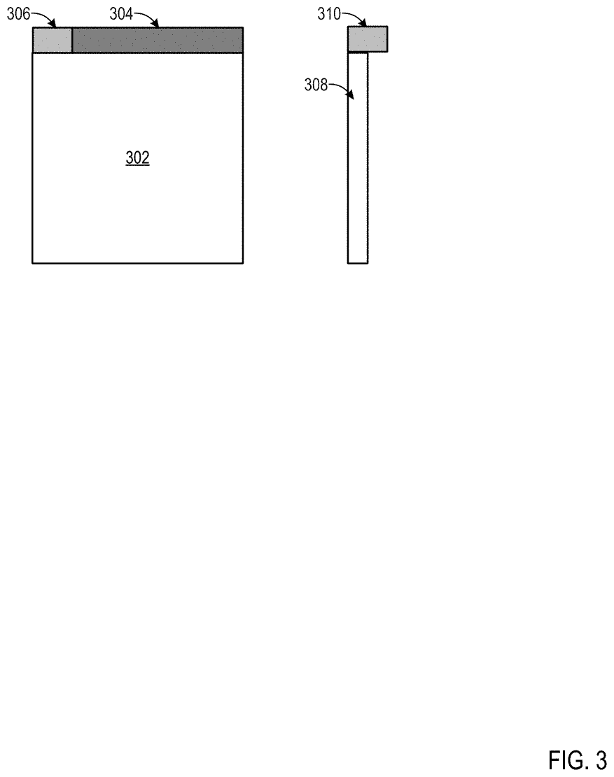

Accordingly, FIG. 3 illustrates how a matrix address space is mapped to memory modules for an efficient PIM implementation. Here, for a given input matrix 302, each value of a row of the input matrix 302 is in a same bank, as shown by item 304, with a portion being in the same SIMD vector as shown by item 306. This simple software mapping strategy is designed to map directly to a typical PIM architecture without any address swapping. However, in order to execute the software on an architecture with a different address mapping, some address bit swapping is necessary to ensure elements being reduced map to the same bank. Also, since each bank may only produce a single output element and different banks can't write adjacent data elements, the output vector 308 will necessarily be sparse, and a subsequent gather operation on the host will necessary to pack output elements from different SIMD lanes together. As shown by item 310, a single value is stored in a given SIMD vector, with the remainder of the values being empty.

As another example embodiment, enforcing data placement requirements via address bit swapping is applied to a convolutional neural network (CNN). As CNN models grow larger and larger, they require more and more data access and larger feature maps, which can include of multiple channels and multiple batches. The optimal way to organize this data in memory is highly dependent on the workload, the layer, and the architecture; some prefer height-width-channel-batch, some prefer batch-channel-width-height, etc. Rather than writing a different version of code for every possible layout ordering (and every combination of input and output layouts), bitswapping allows for a single layout in software, padding the structures to have power of two dimensions, and use bitswapping to remap the structures into the most optimal layout for each layer.

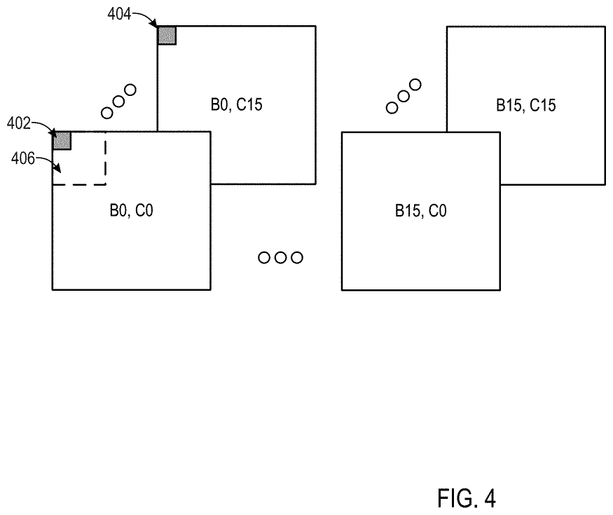

For example, to implement a pooling operation in PIM for layers that are implemented using PIM, neighboring elements within a single feature map are reduced and written to the pooling layer output. Those neighboring input elements must be in the same PIM bank, but ideally they will not be in the same SIMD vector. If they are in the same SIMD vector, then reductions must happen across lanes, incurring added shift operations and reducing the utilization of the vector ALUs. With bitswapping, we can ensure that neighboring elements are in different SIMD vectors but the same bank, enabling optimal PIM performance. This layout is illustrated in FIG. 4. FIG. 4 shows an example CNN feature map with 16 batches and 16 channels. Elements in the same SIMD vector are spread across the channels, as shown using item 402 and item 404. A given pooling window 406 includes values for multiple channels within the same bank.

As a further example embodiment for enforcing data placement requirements via address bit swappings, Bitonic sort involves iteratively performing a comparison step over the entire array. In each step, all elements of an array to be sorted are read, each element is compared with an element some power-of-two stride away (the exact stride value depends on the iteration ID), and the values of these elements are conditionally swapped. Prefix sum exhibits almost the same behavior, but adds the elements together and stores the result to only one of the indices (going forward we discuss bitonic sort behavior, although this discussion applies to prefix sum as well).

A comparison step can be implemented in PIM as long as the two elements being compared map to the same PIM module. However, the distance between the elements to be compared changes over the course of the application. If the array to be sorted can be dynamically remapped to memory using address bit swapping, then it is possible to remap the data at any time such that the next log (PIM module size) iterations will involve comparisons between elements that map to the same PIM module (this is possible because elements are always separated by a power of two). Subsequently, if the stride extends beyond a single memory module, the array can simply be remapped by performing one (or more) iteration(s) on the host between PIM iterations and writing the output to a remapped data structure. Since iterations on the host must read and write the entire array anyways, this simply requires swapping bits in the store addresses of the host iteration such that the elements that need to be compared in next (PIM-executed) iterations will be stored to the same PIM module.

In the case of NUMA, a similar technique can be used to ensure a compute node only needs to compare local elements for a span of iterations. In addition, even when inter-node access is required we can minimize the cost of this remote access. Since reads are generally more performance-critical than writes, we can double-buffer the array and swap bits in the store addresses such that the elements that are read for comparison in the subsequent iteration will exhibit improved locality, shifting remote communication overhead from the load to the store operation.

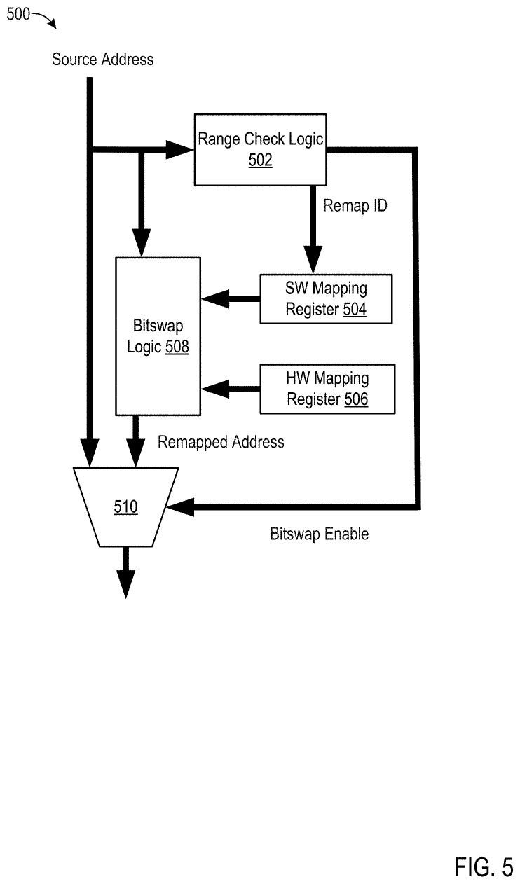

FIG. 5 shows a portion of an example memory access pipeline 500 for enforcing data placement requirements via address bit swapping according to embodiments of the present disclosure. For example, in some embodiments, a bitswap module 110a, is implemented at least in part using the example memory access pipeline 500 or combinations thereof.

In the example memory access pipeline 500, a source address includes a memory address encoded according to a particular address bit mapping (e.g., a software address bit mapping). The source address is provided to a multiplexer 510 and bitswap logic 508. The bitswap logic 508 performs the necessary transformations to convert the source address to a remapped address encoded using another address bit mapping (e.g., a hardware address bit mapping).

In some embodiments, data indicating a software address bit mapping and data indicating a hardware address bit mapping are provided to the bitswap logic 508 to facilitate the bitswap operation converting the source address to the remapped address. For example, the data indicating the software address bit mapping is loaded from a software (SW) mapping register 504 and provided as input to the bitswap logic 508. In some embodiments, the data indicating the software address bit mapping is loaded from a page table (not shown) and provided as input to the bitswap logic 508. In some embodiments, data indicating the hardware address bit mapping is loaded from a hardware (HW) mapping register 506 and provided as input to the bitswap logic 508.

In some embodiments, the source address is provided as input to range check logic 502. The range check logic 502 outputs a signal or data indicating whether the source address falls within a particular memory allocation corresponding to a particular software address bit mapping. If not, the range check logic 502 outputs a negative signal (e.g., to the multiplexer 510) indicating that bitswapping should not be performed. If so, the range check logic 502 outputs a positive signal (e.g., to the multiplexer 510) indicating that bitswapping should be performed. In embodiments where multiple software address bit mappings are used (e.g., each corresponding to multiple SW mapping registers 504 or page table entries), the range check logic 502 outputs an identifier (remap ID) of the particular software address bit mapping in order to select the corresponding data indicating the software address bit mapping.

The source address and the remapped address are provided as input to the multiplexer 510. Either the source address or the remapped address is output depending on an input signal indicating whether bitswapping should be performed (e.g., from the range check logic 502). Thus, if bitswapping should be performed, the remapped address is output. Otherwise, the source address is output.

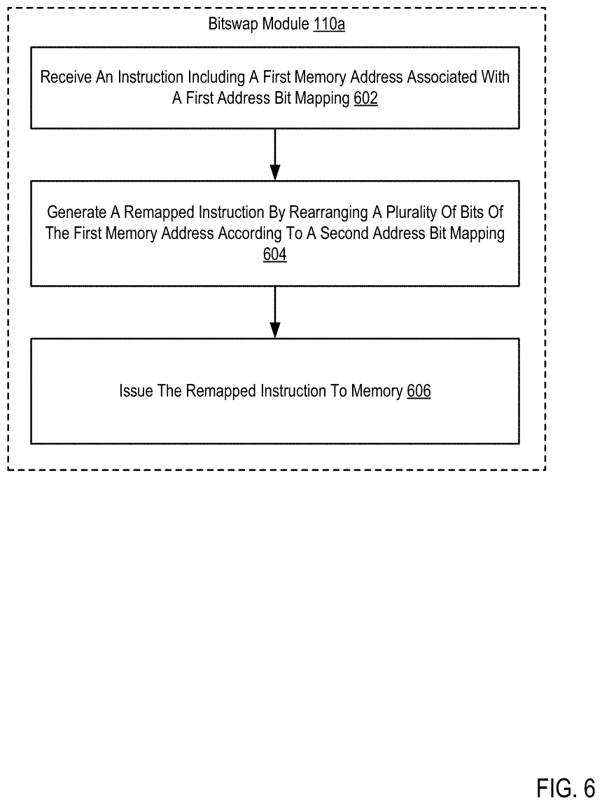

For further explanation, FIG. 6 sets forth a flow chart illustrating an example method for enforcing data placement requirements via address bit swapping that includes receiving 602 (e.g., by a bitswap module 110a) an instruction including a first memory address associated with a first address bit mapping. In some embodiments, the instruction includes an instruction processed by an execution pipeline of a compute node 102a. In some embodiments, the instruction includes an operation directed to a particular portion of memory (e.g., a particular memory module 104a-m. For example, in some embodiments the instruction includes a processing in memory (PIM) operation. The first memory address corresponds to a particular memory address to which the instruction is directed. Accordingly, in some embodiments, the instruction is targeted to a plurality of memory locations associated with (e.g., beginning at) the first memory address.

The first address bit mapping describes a particular mapping of bits in the first memory address (e.g., a virtual memory address) to particular portions of physical memory. The first address bit mapping corresponds to an address bit mapping assumed by the software that generated or caused the instruction to be executed. For example, the first address bit mapping corresponds to a hardware architecture for which the software is developed (e.g., a software address bit mapping) that is different than a hardware architecture executing the software. In some embodiments, the first address bit mapping reserves particular bits for identifying particular portions of memory, or particular offsets to be used when routing or executing the instruction. For example, assuming eight bits encoding address information for a PIM operation, bits 1-2 determine the offset of an element in the PIM vector operation, bits 4-7 determine the bank ID, and bits 5-6 determine the bank offset within a channel. One skilled in the art will understand that this address bit mapping is merely illustrative and that other address bit mappings are within the scope of the disclosed embodiments.

The method of FIG. 6 also includes generating 604 (e.g., by the bitswap module 110a) a remapped instruction by rearranging a plurality of bits of the first memory address according to a second address bit mapping. In other words, the remapped instruction is generated by performing an address bit swap. The second address bit mapping corresponds to an address bit mapping used by the hardware executing the software that generated the instruction (e.g., a hardware address bit mapping). Generating 604 the remapped instruction includes storing the value of a bit at a given index of the first address bit mapping to its corresponding index in the second address bit mapping. Thus, the remapped instruction includes a memory address encoded according to the second address bit mapping that is generated based on the memory address encoded according the first address bit mapping.

Continuing with the example bit encoding scheme above for the first address bit mapping, assume a second address bit mapping where address bits 0 and 1 determine the offset of an element in the PIM operation, bits 3-6 determine the bank ID, and bits 3 and 5 determine the bank offset within a channel. To generate the remapped instruction, as illustrated in item 206 of FIG. 2, the value at index 7 is instead stored at index 6, index 6 stored at index 5, index 5 at index 3, index 4 at index 4, index 3 at index 7, index 2 at index 1, index 1 at index 0, and index 0 at index 2.

In some embodiments, generating 604 the remapped instruction includes performing, in software, one or more bitwise operations on the memory address. To do so, software-level knowledge of the first address bit mapping and second address bit mapping are required. For example, data indicating the first address bit mapping and second address bit mapping are loaded from mapping registers and used when generating 604 the remapped instruction. In some embodiments, generating 604 the remapped instruction is performed by dedicated hardware (e.g., bitwise) logic. Such dedicated hardware logic is included in a memory controller 108a, in an instruction execution pipeline, or otherwise included in a compute node 102a.

The method of FIG. 6 also includes issuing 606 the remapped instruction to memory (e.g., to a particular memory module 104a-m targeted by the remapped instruction). For example, a memory controller 108a issues the remapped instruction via a memory interface 106 to a targeted memory module 104a-m for execution.

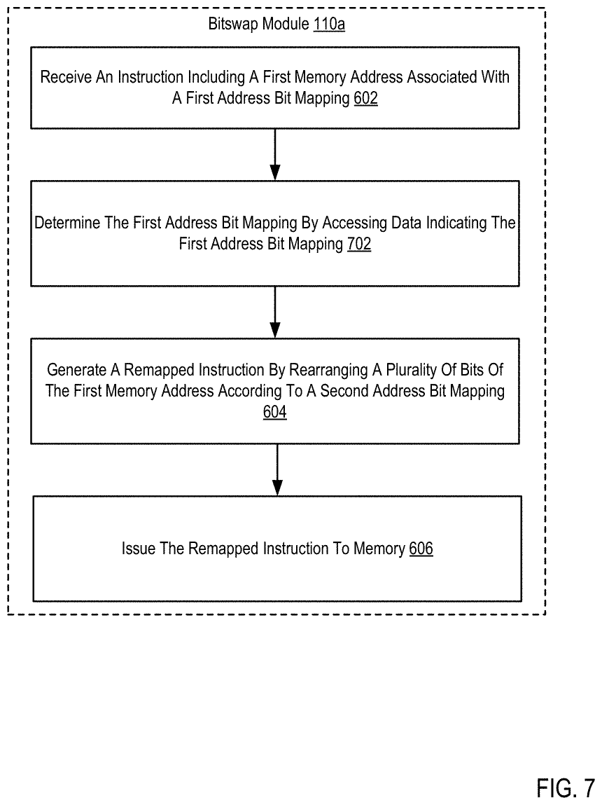

For further explanation, FIG. 7 sets forth a flow chart illustrating an example method for enforcing data placement requirements via address bit swapping according to embodiments of the present disclosure. The method of FIG. 7 is similar to FIG. 6 in that the method of FIG. 7 includes receiving 602 an instruction including a first memory address associated with a first address bit mapping; generating 604 a remapped instruction by rearranging a plurality of bits of the first memory address according to a second address bit mapping; and issuing 606 the remapped instruction to memory.

The method of FIG. 7 differs from FIG. 6 in that the method of FIG. 7 includes determining 702 the first address bit mapping by accessing data indicating the first address bit mapping. In some embodiments, the data indicating the first address bit mapping is accessed from a register (e.g., a mapping register). In other embodiments, the data describing the first address bit mapping is stored in a page table. For example, assuming that allocations as described above are restricted to page-granularity address spaces, the page table stores the data describing the address bit mapping for the corresponding page allocation.

In some embodiments, the data describing the first address bit mapping includes a bitmask indicating the set of address bits that are guaranteed not to change for addresses that are accessed together for a given data structure. In some embodiments, the data describing the first address bit mapping also includes, for multi-address commands, information indicating which addresses in addition to the base address are accessed (e.g., for PIM commands, the address bits indicating byte offset within a single DRAM column access and bank offset within a single channel).

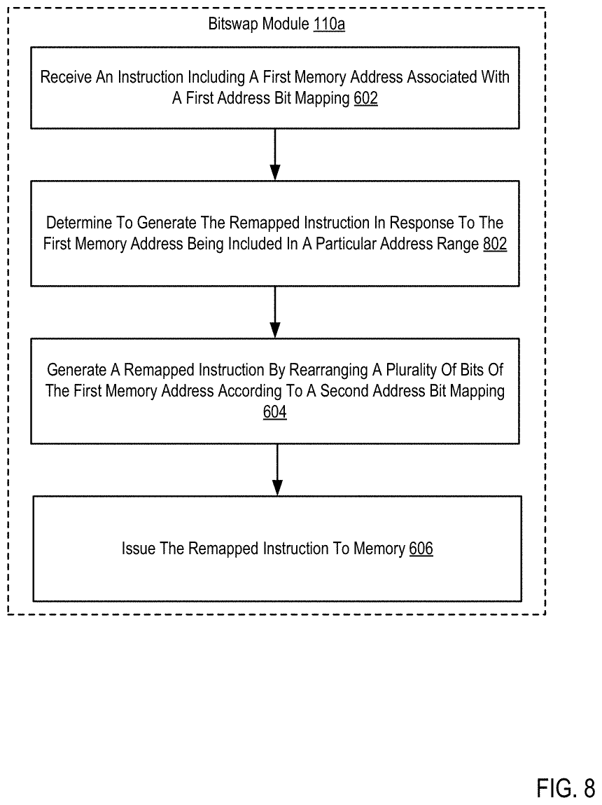

For further explanation, FIG. 8 sets forth a flow chart illustrating an example method for enforcing data placement requirements via address bit swapping according to embodiments of the present disclosure. The method of FIG. 8 is similar to FIG. 6 in that the method of FIG. 8 includes receiving 602 an instruction including a first memory address associated with a first address bit mapping; generating 604 a remapped instruction by rearranging a plurality of bits of the first memory address according to a second address bit mapping; and issuing 606 the remapped instruction to memory.

The method of FIG. 8 differs from FIG. 6 in that the method of FIG. 8 includes determining 802 to generate the remapped instruction in response to the first memory address being included in a particular address range. For example, an address range is defined by one or more software instructions, where the address range is associated with a particular address bit mapping. Thus, any instructions targeting a memory address in the address range should have an address bit swap performed in order to conform with a hardware address bit mapping (e.g., the second address bit mapping). Accordingly, the bitswap module 110a determines if the memory address of the instruction falls within the particular address range. If so, the memory address should have an address bit swap applied, thereby causing the remapped instruction to be generated.

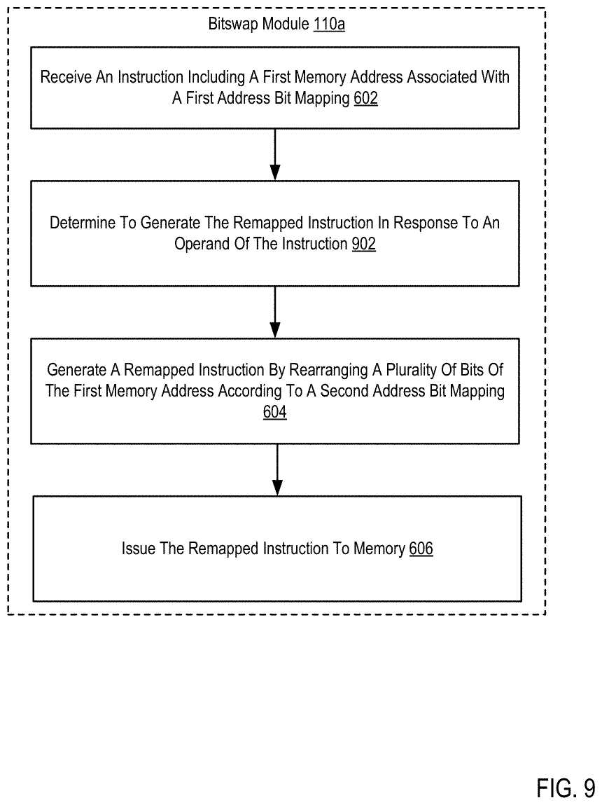

For further explanation, FIG. 9 sets forth a flow chart illustrating an example method for enforcing data placement requirements via address bit swapping according to embodiments of the present disclosure. The method of FIG. 9 is similar to FIG. 6 in that the method of FIG. 9 includes receiving 602 an instruction including a first memory address associated with a first address bit mapping; generating 604 a remapped instruction by rearranging a plurality of bits of the first memory address according to a second address bit mapping; and issuing 606 the remapped instruction to memory.

The method of FIG. 9 differs from FIG. 6 in that the method of FIG. 9 includes determining 902 to generate the remapped instruction in response to an operand of the instruction. Thus, instructions that access memory and do not include the particular operand will not be subject to an address bit swap by the bitswap module 110a-n, while instructions that access memory and do include the particular operand will be subject to an address bit swap. In some embodiments, the operand includes an identifier of a mapping register storing data indicating the address bit mapping to be used in the address bit swap (e.g., the first address bit mapping). In other embodiments, this mapping register identifier is included as an additional operand.

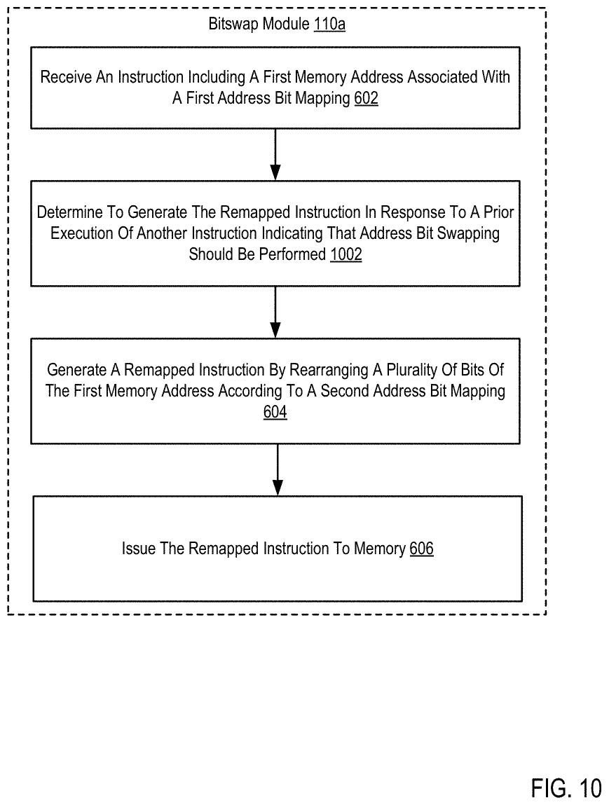

For further explanation, FIG. 10 sets forth a flow chart illustrating an example method for enforcing data placement requirements via address bit swapping according to embodiments of the present disclosure. The method of FIG. 10 is similar to FIG. 6 in that the method of FIG. 10 includes receiving 602 an instruction including a first memory address associated with a first address bit mapping; generating 604 a remapped instruction by rearranging a plurality of bits of the first memory address according to a second address bit mapping; and issuing 606 the remapped instruction to memory.

The method of FIG. 10 differs from FIG. 6 in that the method of FIG. 10 includes determining 1002 to generate the remapped instruction in response to a prior execution of another instruction indicating that address bit swapping should be performed. For example, execution of a “bitswap start” instruction triggers entry into an address bit swap mode whereby subsequently executed instructions including a memory access would be subject to an address bit swap of memory address bits. Execution of a “bitswap end” instruction would end the address bit swap mode, whereby subsequently executed instructions with memory accesses would be issued to memory without address bit swapping. In some embodiments, the bitswap start instruction includes, as an operand, an identifier of a mapping register storing the data indicating the software address bit mapping to be used in the address bit swap.

In view of the explanations set forth above, readers will recognize that the benefits of enforcing data placement requirements via address bit swapping include:
Improved performance of a computing system by allowing for operations with particular data placement requirements to be executed across different hardware architectures without hardware-specific software programming requirements.

Exemplary embodiments of the present disclosure are described largely in the context of a fully functional computer system for enforcing data placement requirements via address bit swapping. Readers of skill in the art will recognize, however, that the present disclosure also can be embodied in a computer program product disposed upon computer readable storage media for use with any suitable data processing system. Such computer readable storage media can be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes can be made in various embodiments of the present disclosure. The descriptions in this specification are for purposes of illustration only and are not to be construed in a limiting sense. The scope of the present disclosure is limited only by the language of the following claims.

1. A method of enforcing data placement requirements via address bit swapping, the method comprising:
receiving an instruction comprising a first memory address associated with a first address bit mapping;
generating a remapped instruction by rearranging a plurality of bits of the first memory address according to a second address bit mapping; and
issuing the remapped instruction to memory.

2. The method of claim 1, wherein the second address bit mapping corresponds to a hardware architecture associated with an execution of the instruction.

3. The method of claim 1, further comprising determining the first address bit mapping by accessing data indicating the first address bit mapping.

4. The method of claim 3, wherein the data indicating the first address bit mapping is stored in a page table.

5. The method of claim 3, wherein the data indicating the first address bit mapping is stored in a mapping register.

6. The method of claim 3, wherein the data indicating the first address bit mapping comprises a bit mask indicating a plurality of bits that will not change for addresses that will be accessed together in one or more data structures.

7. The method of claim 1, further comprising determining to generate the remapped instruction in response to the first memory address being included in a particular address range.

8. The method of claim 1, further comprising determining to generate the remapped instruction in response to an operand of the instruction.

9. The method of claim 1, further comprising determining to generate the remapped instruction in response to a prior execution of another instruction indicating that address bit swapping should be performed.

10. An apparatus for enforcing data placement requirements via address bit swapping, the apparatus configured to perform steps comprising:
receiving an instruction comprising a first memory address associated with a first address bit mapping;
generating a remapped instruction by rearranging a plurality of bits of the first memory address according to a second address bit mapping; and
issuing the remapped instruction to memory.

11. The apparatus of claim 10, wherein the second address bit mapping corresponds to a hardware architecture associated with an execution of the instruction.

12. The apparatus of claim 10, wherein the steps further comprise determining the first address bit mapping by accessing data indicating the first address bit mapping.

13. The apparatus of claim 12, wherein the data indicating the first address bit mapping is stored in a page table.

14. The apparatus of claim 12, wherein the data indicating the first address bit mapping is stored in a mapping register.

15. The apparatus of claim 12, wherein the data indicating the first address bit mapping comprises a bit mask indicating a plurality of bits that will not change when accessing multiple addresses for one or more data structures.

16. The apparatus of claim 10, wherein the steps further comprise determining to generate the remapped instruction in response to the first memory address being included in a particular address range.

17. The apparatus of claim 10, wherein the steps further comprise determining to generate the remapped instruction in response to an operand of the instruction.

18. The apparatus of claim 10, wherein the steps further comprise determining to generate the remapped instruction in response to a prior execution of another instruction indicating that address bit swapping should be performed.

19. A computer program product disposed upon a non-transitory computer readable medium, the computer program product comprising computer program instructions for enforcing data placement requirements via address bit swapping that, when executed, cause a computer system to perform steps comprising:
receiving an instruction comprising a first memory address associated with a first address bit mapping;
generating a remapped instruction by rearranging a plurality of bits of the first memory address according to a second address bit mapping; and
issuing the remapped instruction to memory.

20. The computer program product of claim 19, wherein the second address bit mapping corresponds to a hardware architecture associated with an execution of the instruction.
